(19) United States
(12) Patent Application Publication
(10) Pub. No.: US 2013/0346136 A1
(43) Pub. Date: Dec. 26, 2013

(54) Services Sales Cockpit

(71) Applicants: Oleg Figlin, Kingston Upon Thames (GB); Trevor Johns, Kent (GB)

(72) Inventors: Oleg Figlin, Kingston Upon Thames (GB); Trevor Johns, Kent (GB)

(73) Assignee: SAP AG, Walldorf (DE)

(21) Appl. No.: 13/532,413

(22) Filed: Jun. 25, 2012

(51) Int. Cl. G06Q 10/06

(52) U.S. Cl. 705/7.23

(57) ABSTRACT

A method, a system, and computer-readable medium for processing of data are disclosed. At least one customer requirement concerning at least one business process and at least one customer requirement concerning at least one non-business process related activity are determined. A mapping of determined customer requirements to at least one available service is generated. Mapped customer requirements and available services are mapped into a project. A pricing for the project is generated.

### TECHNICAL FIELD

This disclosure relates generally to data processing and, in particular, to providing selection of services for customers.

### BACKGROUND

Many services-oriented companies have a significant number of services and/or solutions that they can offer to their customers. For example, SAP AG, Walldorf, Germany, has a service portfolio that includes more than 600 different services. Sales representatives of such companies typically have a limited visibility into and understanding of what is contained in the services portfolio because the portfolio can evolve on a monthly basis. The representatives further might not understand the detail of the scope of all services that are being offered by the company. As a result, many company services might not be offered to the customers and thus, are not sold.

A search for the right service is difficult as it can require conducting a detailed fit/gap analysis to understand if a particular service fits various customer requirements. Further, in assemble-to-order services systems, system support for easy assembly of services based on customer requirements can be required. This makes it even more difficult to find the right service unless there exists a tool and/or an application that can summarize customer requirements and identify services that can fit customer's needs.

### SUMMARY

In some implementations, the current subject matter relates to a computer-implemented method. The method can include determining at least one customer requirement concerning at least one business process and at least one customer requirement concerning at least one non-business process related activity, generating a mapping of determined customer requirements to at least one available service, assembling mapped customer requirements and available services into a project, and generating a pricing for the project. At least one of the determining, the generating the mapping, the assembling, and the generating the pricing can be performed on at least one processor.

In some implementations, the current subject matter can include one or more of the following optional features. At least one available service can include at least one of the following: at least one business process and at least one non-business process activity. At least one business process and at least one non-business process activity can form at least one solution package.

In some implementations, the generating can include generating a mapping of the at least one solution to the assembled customer requirements.

In some implementations, the method can include determining whether a plurality of solution packages address at least one same business process. The method can also include excluding at least one solution package from the plurality of solution package.

In some implementations, the determining can include determining, based on the determined at least one customer requirement, a category of business processes and a category of non-business process related activities.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary process for exploration, delivery and operation of the solution to the customer, according to some implementations of the current subject matter.

FIG. 2 illustrates an exemplary user interface for scoping a customer opportunity, according to some implementations of the current subject matter.

FIG. 3 illustrates an exemplary user interface for determining business processes as part of the scoping of the customer opportunity, according to some implementations of the current subject matter.

FIG. 4 illustrates an exemplary user interface for determining non-business process activity as of the scoping of the customer opportunity, according to some implementations of the current subject matter.

FIG. 5 illustrates an exemplary user interface summarizing selected business processes and non-business process related activities as part of the scoping of the customer opportunity, according to some implementations of the current subject matter.

FIGS. 6a-b illustrates an exemplary user interface showing assembling of packages in response to the customer's request for solution, according to some implementations of the current subject matter.

FIG. 7 illustrates an exemplary system, according to some implementations of the current subject matter.

FIG. 8 illustrates an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for providing matching of customer requirements concerning various business processes and/or non-business processes to a plurality of available services that are being offered by a company to its customers and selecting, based on such matching an appropriate service that matches customer requirements.

A customer seeking to purchase a particular service or solution from a company can have various requirements that can be driven by the customer's system specifications, operational constraints, and/or general/specific needs of the customer. In order for the purchased solution to properly operate in the customer's system environment, the customer can require that the solution satisfy those requirements. Otherwise, the solution can operate improperly or be entirely inoperable, which can cause financial harm and aggravation to the customer.

In some implementations, the current subject matter relates to systems and methods that can summarize customer requirements in various areas related to customer's business. Some examples of such areas can include business processes that can be requested by the customer from the vendor of a solution sought by the customer, non-business process related activities (e.g., trainings, data migration, installation, and others) that can be also requested by the customer from the vendor of the solution, and/or any other requirements that are not related to the specific requested business processes and specific requested non-business process related activities. The latter requirements can be deemed to be “free-text” requirements of the customer and can contain various customer instructions, descriptions, needs, wishes, etc.

The current subject matter can map customer requirements to the scope of available services that can be offered by the vendor for purchase. The customer requirements can also be mapped to other content blocks (e.g., best practices, implementation parameters, etc.), which can be assembled into a project. A project can represent the solution that is sought by the customer in view of the customer's requirements. Once the project is assembled, the vendor can provide an estimated pricing for all assembled pieces individually as well as a total price for the project. In some implementations, the current subject matter can include an artificial intelligence capability that allows learning from previous customer's requests for services and resulting projects to suggest services/content blocks that can be incorporated into the current project and/or future projects for the customer and/or other customers.

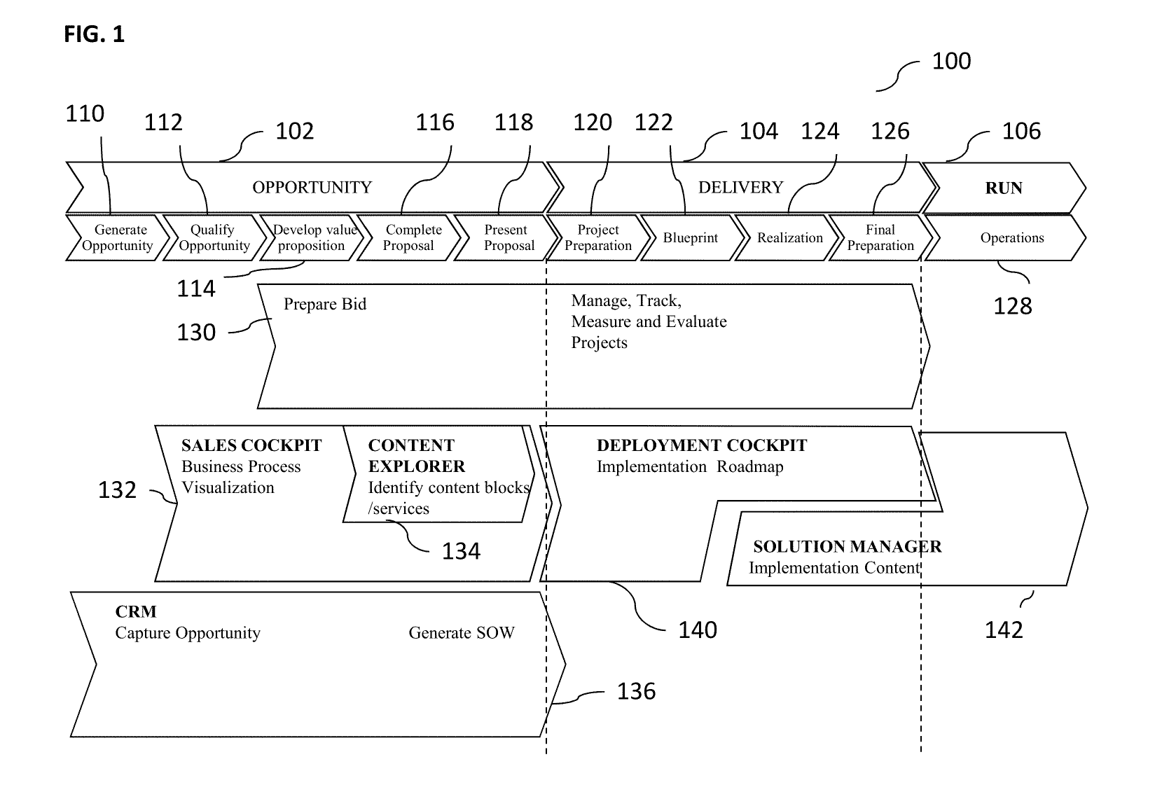

In some implementations, when a customer approaches a vendor of solutions with a request for a particular solution, the process for exploration, delivery and operation of the solution to the customer can be divided into three phases: opportunity phase 102, delivery phase 104 and run phase 106, as shown in FIG. 1. During the opportunity phase 102, the customer's needs and requirements concerning a particular solution can be explored. The opportunity can be captured as a result of the customer coming directly to the vendor indicating a need for a particular solution that may or may not be offered by the vendor, the vendor directly contacting the customer with an offer to purchase a particular solution, and/or using any other ways. The solution can include a single solution, a plurality of solutions, an off-the-shelf solution available from the vendor, a custom-built solution that is tailored to the customer, and/or any other solution. The solution can be software, hardware, and/or a combination of hardware and software. It can relate to business processes, non-business process activities, networking, management, sales, purchasing, training, testing, implementation, and/or any other aspect(s) of customer's business. While in phase 102, the vendor of the solution and the customer can communicate with one another to determine the actual scope of the customer needs/requirements. Based on the determined scope, the vendor can generate a proposal to the customer along with various details concerning implementation, operation, pricing, etc.

As shown in FIG. 1, the opportunity phase 102 can have various sub-phases, which can include generation of opportunity 110, qualifying an opportunity 112, developing of value proposition 114, completion of proposal 116, and presentation of the proposal 118. In some implementations, a customer relationship management (“CRM”) system can be implemented to assist in capturing the customer opportunity and generating an appropriate statement of work (“SOW”) in connection with customer opportunity, as indicated by block 136 in FIG. 1. The SOW can identify what the vendor needs to do to deliver a proposal to the customer concerning the solution sought by the customer. A CRM is a model for managing vendor's interactions with customers, clients, and sales prospects. It can organize, automate, and synchronize business processes, e.g., sales activities, marketing, customer service, and/or technical support. The CRM can assist the vendor throughout all sub-phases 110-118.

As stated above, generation of the opportunity sub-phase 102 can involve the customer coming directly to the vendor indicating a need for a particular solution, the vendor directly contacting the customer with an offer to purchase a particular solution, and/or via any other means. Once the opportunity is generated, the opportunity can be qualified in the sub-phase 104 by determining available solutions, scope of required work, visualizing business processes that may be involved in the solution as well as any other requirements related to the customer's request for solution. At this stage, a sales cockpit can be involved in such visualizing business process(es), as indicated by block 132. The sales cockpit can also implement a content explorer feature (shown by block 134) that can identify various content blocks/services that are available from the vendor in view of customer's requirements for a particular solution. The content explorer feature can search vendor databases for information related to the customer's request and can further use any available prior knowledge concerning previously developed solutions for the same customer and/or any other customers.

The sales cockpit 132 can determine high-level scope options when preparing a bid for the customer in response to the customer's request for a solution. For example, the sales cockpit 132 can be used to select any relevant business processes to a business process that can identified in connection with the customer's request for a solution. In some implementations, a business process repository of the vendor can be used to determine whether or not there exist any such relevant business processes. The sales cockpit 132 can also determine whether customer's request includes any of the non-business process related activities and select such activities from a list of activities that are available from the vendor. Further, any selected business processes and non-business process related activities can be linked to various reusable content (e.g., services, Best Practices, ASAP Add-Ons, any historical data concerning previously developed solutions, etc.) that can be available from vendor's databases/repositories. Any processes/activities that cannot be linked to reusable content can be defined as gap requirements. Such gap requirements can be used to determine any additional information that is needed for answering customer's request for a solution. Once the sales cockpit 132 completes gathering of the information, the resulting assembled information (detailed scope, identified reusable content, gap requirements, etc.) can be transferred to the deployment cockpit 140 and used during the delivery phase 104.

Upon completion of the qualification of the opportunity sub-phase 112, the vendor can prepare a bid to present to the customer, as indicated by the block 130, where the bid can encompass details of the solution, operational requirements, etc. as well as pricing, and/or any other recommendations to the customer. During bid preparation, sub-phases 114, 116 and 118 can occur and can result in completion and presentation of the solution proposal to the customer. Presentation of the solution proposal to the customer can complete the opportunity phase 102. As such, by the end of the opportunity phase 102, the customer can have full information, including what the proposed solution is, its requirements, operational characteristics, environments, etc., solution's pricing, and/or any other information that may be pertinent to the proposed solution and/or customer's understanding what the solution entails. All of the information related to the solution can be assembled into a project that can be delivered to the customer upon customer's acceptance of the vendor's proposal.

When the customer accepts the vendor's proposal, the delivery phase 104 can be initiated. The delivery phase 104 can include a project preparation sub-phase 120, a blueprint sub-phase 122, a realization sub-phase 124, and final preparation sub-phase 126. A deployment cockpit that provides an implementation road can assist during the delivery phase 104 of the project, as indicated by block 140. A solution manager can assist with content implementation during the delivery phase 104 as well as the run phase 106, as shown by block 142.

During the delivery phase 104, the proposed project can be prepared for implementation in the customer's system, which can include developing a blueprint for implementation of the project, realization requirements and milestones of the project in the customer's system, and a final preparation of the project for running in the customer's system, which can involve troubleshooting, compiling, and testing of various features of the proposed solution in the customer system.

Once the delivery phase 104 is completed, the run phase 106 that includes an operations sub-phase 128 begins. The run phase 106 can be assisted by the solution manager 142 that can deal with implementation of various content in accordance with constraints and requirements of the delivered solution.

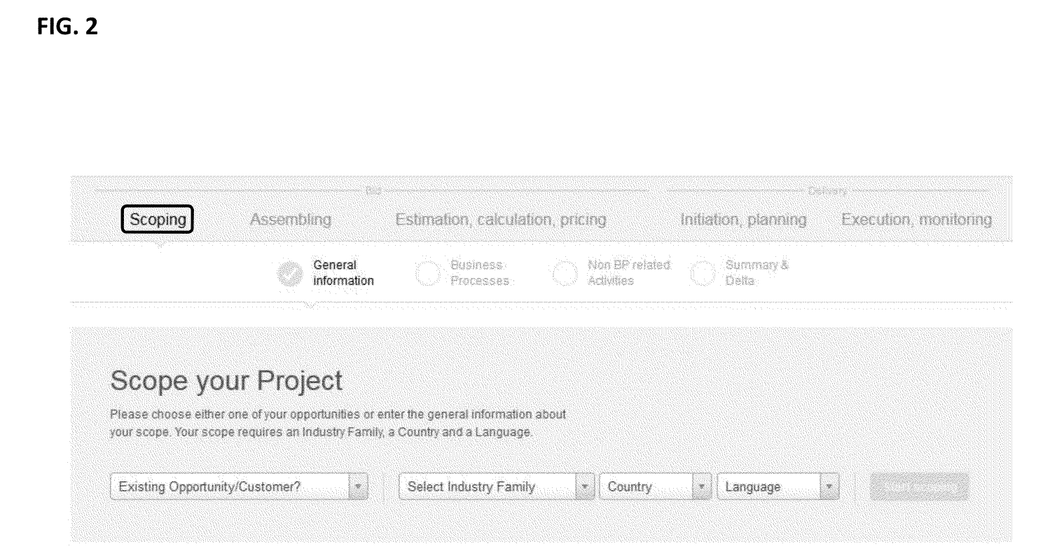

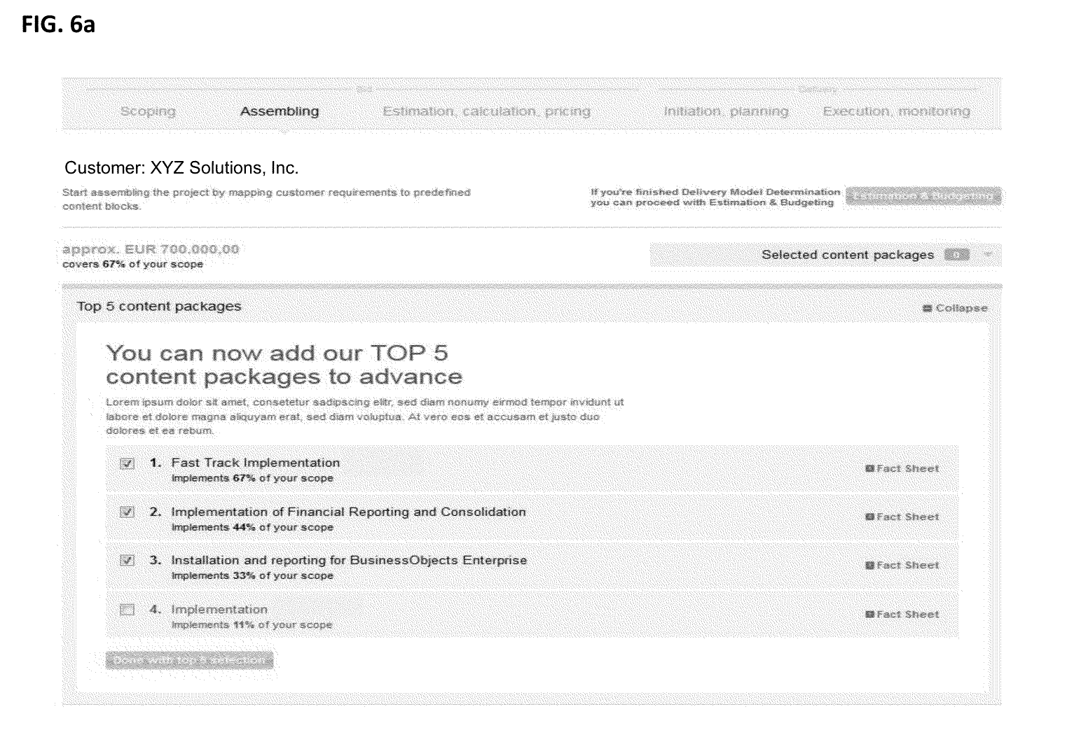

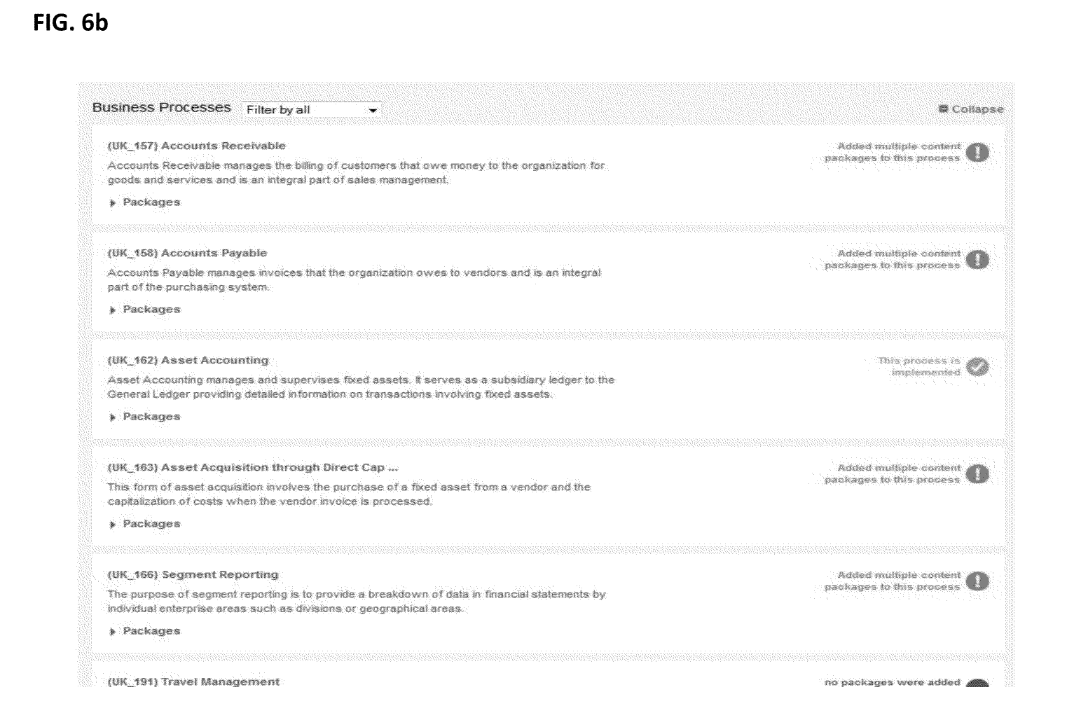

FIGS. 2-5 illustrate exemplary user interfaces during the scoping the opportunity phase when responding to the customer's request for a solution and FIGS. 6a-b illustrate exemplary user interfaces during assembling of the service/solution packages that can be responsive to the customer's request for a solution. The user interfaces can be implemented as part of the sales cockpit 132 and employed by the user (e.g., sales representative, manager, etc.) in determining what is needed by the customer in response to customer's request for a solution.

As shown in FIG. 2, the scoping of an opportunity can begin by providing general information about the customer and the customer's request for a solution. The information can be concerning an existing customer, customer's industry family, customer's country, customer's language, and/or any other information. A user of the sales cockpit 132 can be asked to provide this information upon receiving a solution request from a customer. The user can be a sales representative, a sales manager, and/or any other vendor representative that can be working on providing a response to the customer's request.

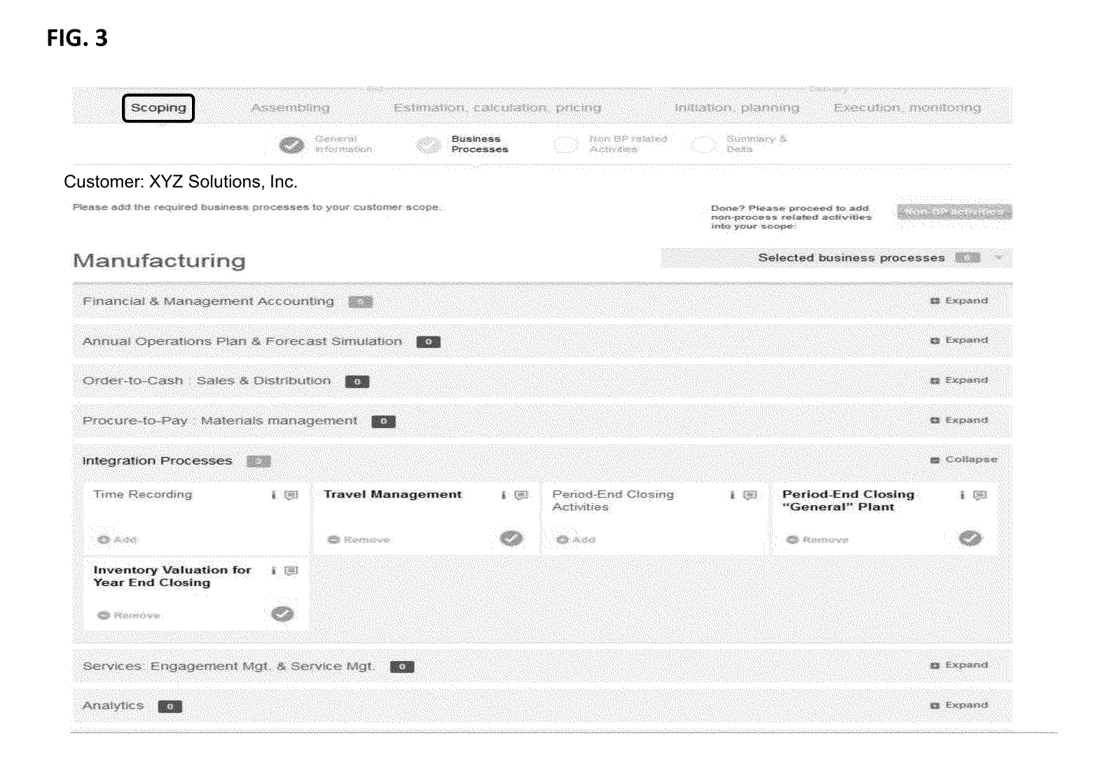

After providing the general information, the customer's company name (XYZ Solutions, Inc.) along with any other information can be displayed in the user interface, as shown in FIG. 3. various business processes that may be relevant to the customer's request for solution can be added/selected. The user interface can a group of business processes (“Manufacturing”) along with available business processes sub-groups (“Financial & Management Accounting”, “Annual Operations Plan & Forecast Simulation”, “Order-to-Cash: Sales & Distribution”, Procure-to-Pay: Materials Management”, “Integration Processes”, “Services: Engagement Mgt. & Service Mgt.”, and “Analytics”). Each sub-group can also include a plurality of business processes and such processes can be displayed on the user interface upon clicking on an “Expand” button. For example, the “Integration Processes” sub-group can include five separate business processes: “Time Recording”, “Travel Management”, “Period-End Closing Activities”, “Period-End Closing ‘General’ Plant” and “Inventory Valuation for Year End Closing”. One or more of these processes can be selected by the user to be included in the proposal to the customer. The arrangement of the categories, the sub-categories, as well as specific business processes in the categories/sub-categories can be predetermined by the vendor system in a generic (e.g., non-customer specific) fashion and/or selected for the specific customer based either on that customer's previous dealings with the vendor or vendor's dealings with other customers, and/or based on any other parameters. Once the specific business processes in a sub-group of processes are displayed, the user can choose to select specific processes. As shown in FIG. 3, in the “Integration Processes” sub-group, business processes of “Travel Management”, “Period-End Closing ‘General’ Plant” and “Inventory Valuation for Year End Closing” are selected. If the user desires to add further processes in the same sub-group (if available), the user can click on the “Add” button. The selected processes are shown by a check-mark indicative of the process being selected. The user can also choose to remove a particular selected process by clicking “Remove” button. The user interface can also indicate how many total processes have been selected. As shown in FIG. 3, eight total processes in the “Manufacturing” group have been selected: five in the “Financial & Management Accounting” sub-group and three in the “Integration Processes” category. The user can select/de-select any other processes that may be available from the vendor collection of business processes and/or that may be displayed in the user interface. In some implementations, the vendor system can determine whether one selected business process is compatible with another selected business process, whether a selected business process requires another business process, and/or determine any other compatibility information.

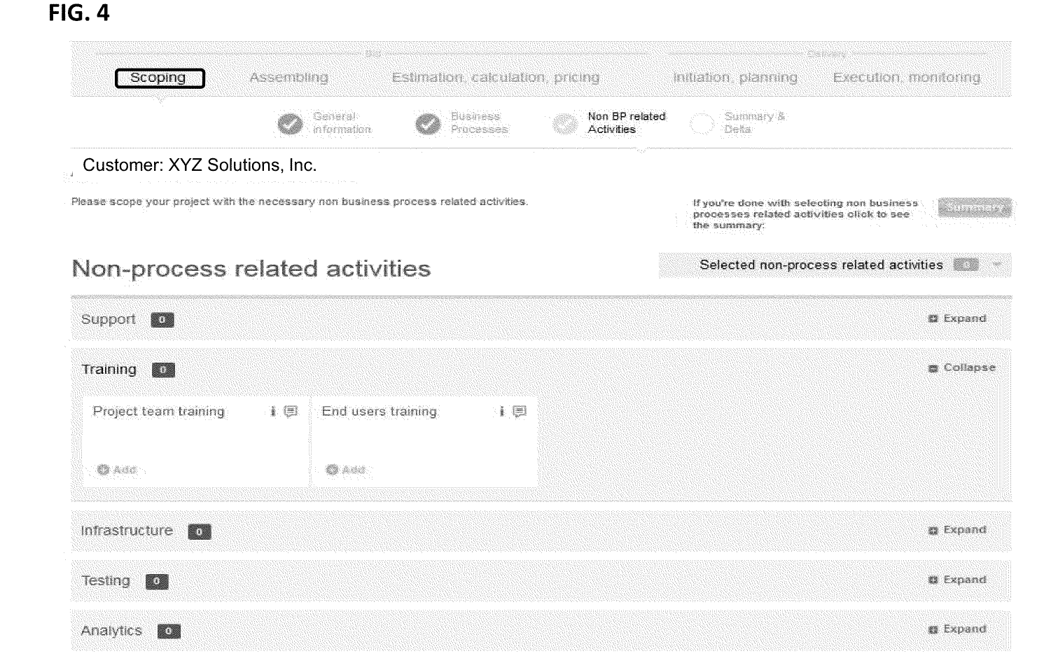

Once the business processes are selected, the user proceeds to selection of non-business process related activities, as shown in FIG. 4. The user interface for selection of non-business process related activities can be similar to the user interface for selection of business processes. As shown in FIG. 4, the non-business process related activity groups can include: “Support”, “Training”, “Infrastructure”, “Testing”, and “Analytics”. Each activity group can include at least one activity. For example, the “Training” group can include the following activities: “Project Team Training” and “End Users Training” The user can choose to add one or more such activities by clicking an “Add” button. If an activity is added, but the user wishes to remove it, the user can click “Remove” button. Further, each activity can include an information icon next to it, which the user can click to see the description of the activity. The vendor system can also determine whether or not any of the selected activities are or are not compatible with the other activities and/or processes and/or require other activities/processes, and/or determine other compatibility options.

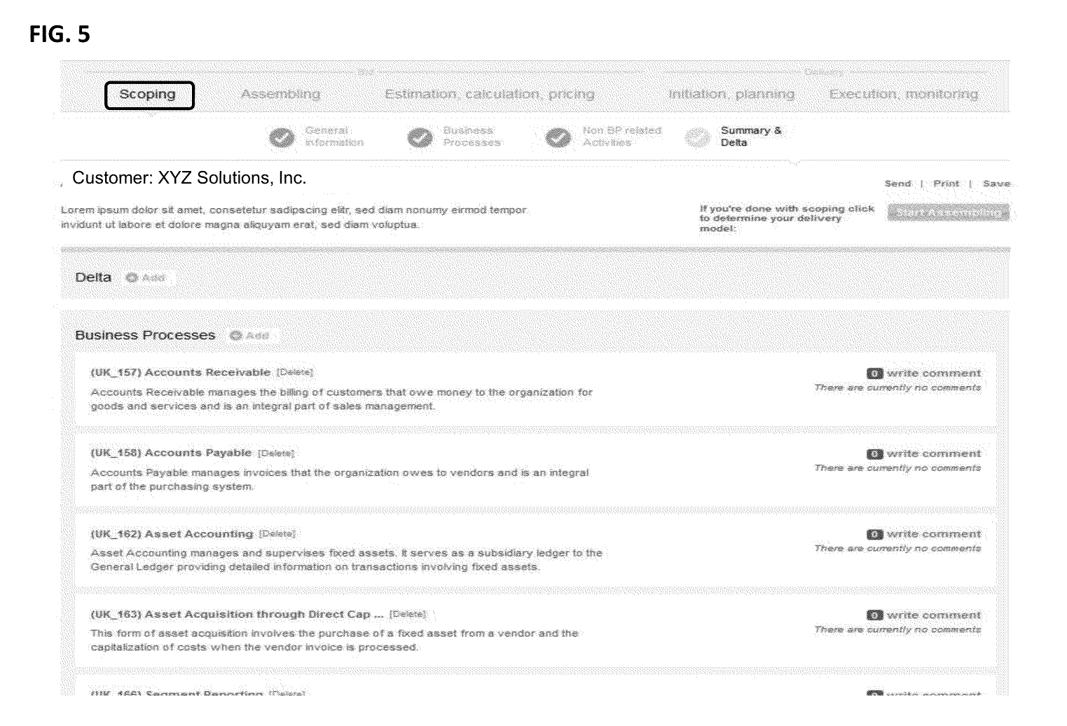

FIG. 5 illustrates an exemplary user interface that shows all added business processes and/or non-business process related activities. At this junction, the user can also have an opportunity remove any added processes/activities by clicking “Delete” button as well as add comments to the added processes/activities. Once the processes/activities are added, the user can begin assembly process by clicking “Start Assembling” button on the user interface.

An exemplary user interface for an assembly process is illustrated in FIGS. 6a-b. The assembly process user interface illustrates available solution packages that can be selected by the user to address the previously added processes/activities. The user interface can also indicate costs that can be associated with the selected packages and a percentage of the scope of the project that can be addressed by the selected package(s). As shown in FIG. 6a, some of the available packages can include: “Fast Track Implementation”, “Implementation of Financial Reporting and Consolidation”, “Installation and Reporting for Business Objects Enterprise”, “and “Implementation” packages. The user can click to select a package and see a fact sheet concerning the package, where the fact sheet can indicate details about the selected package. In some implementations, the vendor system can also determine compatibility of selected packages, whether selected packages require other packages/processes/activities, as well as perform other compatibility functions. Further, the user can be configured to select a package based on a particular added business process and/or activity, as shown in FIG. 6b. Additionally, the vendor system can determine whether one process/activity can be addressed by multiple packages and if so, recommendations can be provided to the user to select/de-select various packages/processes/activities.

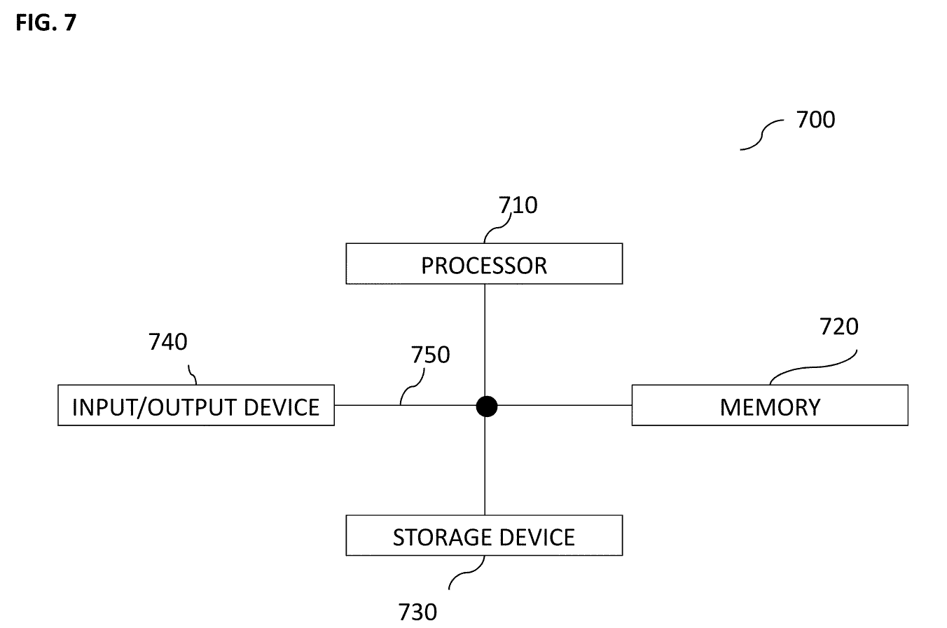

In some implementations, the current subject matter can be configured to be implemented in a system 700, as shown in FIG. 7. The system 700 can include a processor 710, a memory 720, a storage device 730, and an input/output device 740. Each of the components 710, 720, 730 and 740 can be interconnected using a system bus 750. The processor 710 can be configured to process instructions for execution within the system 700. In some implementations, the processor 710 can be a single-threaded processor. In alternate implementations, the processor 710 can be a multi-threaded processor. The processor 710 can be further configured to process instructions stored in the memory 720 or on the storage device 730, including receiving or sending information through the input/output device 740. The memory 720 can store information within the system 700. In some implementations, the memory 720 can be a computer-readable medium. In alternate implementations, the memory 720 can be a volatile memory unit. In yet some implementations, the memory 720 can be a non-volatile memory unit. The storage device 730 can be capable of providing mass storage for the system 700. In some implementations, the storage device 730 can be a computer-readable medium. In alternate implementations, the storage device 730 can be a floppy disk device, a hard disk device, an optical disk device, a tape device, non-volatile solid state memory, or any other type of storage device. The input/output device 740 can be configured to provide input/output operations for the system 700. In some implementations, the input/output device 740 can include a keyboard and/or pointing device. In alternate implementations, the input/output device 740 can include a display unit for displaying graphical user interfaces.

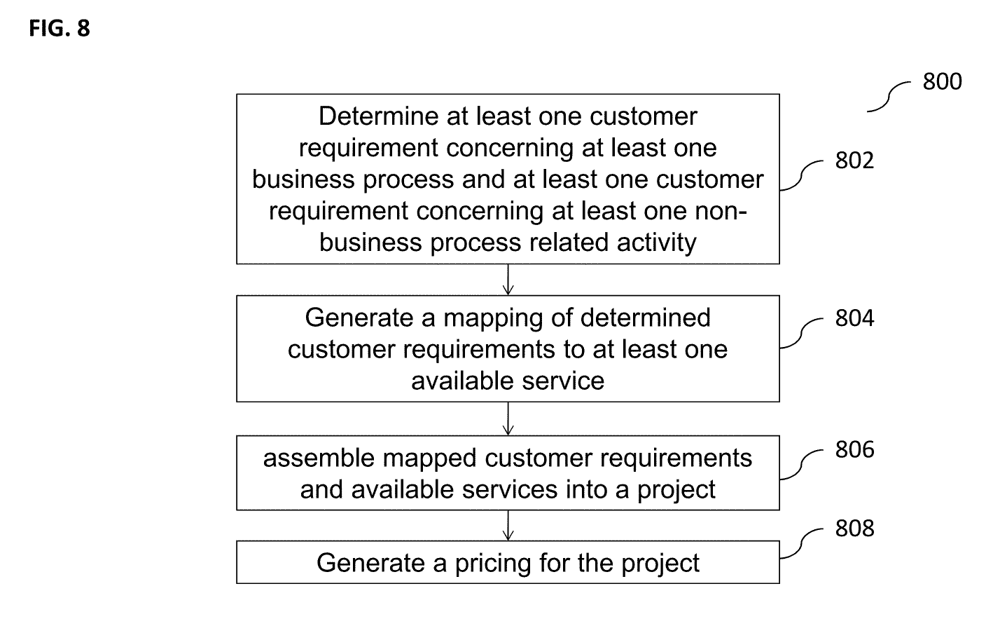

FIG. 8 illustrates an exemplary method 800, according to some implementations of the current subject matter. At 802, at least one customer requirement concerning at least one business process and at least one customer requirement concerning at least one non-business process related activity can be determined. At 804, a mapping of determined customer requirements to at least one available service can be generated. At 806, mapped customer requirements and available services into a project can be assembled. At 808, a pricing for the project can be generated. At least one of the determining, the generating the mapping, the assembling, and the generating the pricing can be performed on at least one processor.

In some implementations, the current subject matter can include one or more following optional features. At least one available service can include at least one of the following: at least one business process and at least one non-business process activity. At least one business process and at least one non-business process activity can form at least one solution package.

In some implementations, the generating can include generating a mapping of the at least one solution to the assembled customer requirements. The method can also include determining whether a plurality of solution packages address at least one same business process and excluding at least one solution package from the plurality of solution package.

The determining can include determining, based on the determined at least one customer requirement, a category of business processes and a category of non-business process related activities.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
determining at least one customer requirement concerning at least one business process and at least one customer requirement concerning at least one non-business process related activity;
generating a mapping of determined customer requirements to at least one available service;
assembling mapped customer requirements and available services into a project; and
generating a pricing for the project;
wherein the at least one of the determining, the generating the mapping, the assembling, and the generating the pricing is performed on at least one processor.

2. The method according to claim 1, wherein the at least one available service includes at least one of the following: at least one business process and at least one non-business process activity.

3. The method according to claim 2, wherein the at least one business process and the at least one non-business process activity form at least one solution package.

4. The method according to claim 3, wherein the generating further comprises
generating a mapping of the at least one solution to the assembled customer requirements.

5. The method according to claim 3, further comprising
determining whether a plurality of solution packages address at least one same business process.

6. The method according to claim 5, further comprising
excluding at least one solution package from the plurality of solution package.

7. The method according to claim 1, wherein the determining further comprises
determining, based on the determined at least one customer requirement, a category of business processes and a category of non-business process related activities.

8. A computer program product comprising a machine-readable medium storing instructions that, when executed by at least one programmable processor, cause the at least one programmable processor to perform operations comprising:
determining at least one customer requirement concerning at least one business process and at least one customer requirement concerning at least one non-business process related activity;
generating a mapping of determined customer requirements to at least one available service;
assembling mapped customer requirements and available services into a project; and
generating a pricing for the project.

9. The computer program product according to claim 8, wherein the at least one available service includes at least one of the following: at least one business process and at least one non-business process activity.

10. The computer program product according to claim 9, wherein the at least one business process and the at least one non-business process activity form at least one solution package.

11. The computer program product according to claim 10, wherein the generating further comprises
generating a mapping of the at least one solution to the assembled customer requirements.

12. The computer program product according to claim 10, wherein the operations further comprise
determining whether a plurality of solution packages address at least one same business process.

13. The computer program product according to claim 12, wherein the operations further comprise
excluding at least one solution package from the plurality of solution package.

14. The computer program product according to claim 8, wherein the determining further comprises
determining, based on the determined at least one customer requirement, a category of business processes and a category of non-business process related activities.

15. A system comprising:
at least one programmable processor; and
a machine-readable medium storing instructions that, when executed by the at least one programmable processor, cause the at least one programmable processor to perform operations comprising:
determining at least one customer requirement concerning at least one business process and at least one customer requirement concerning at least one non-business process related activity;
generating a mapping of determined customer requirements to at least one available service;
assembling mapped customer requirements and available services into a project; and
generating a pricing for the project.

16. The system according to claim 15, wherein the at least one available service includes at least one of the following: at least one business process and at least one non-business process activity; and
wherein the at least one business process and the at least one non-business process activity form at least one solution package.

17. The system according to claim 16, wherein the generating further comprises
generating a mapping of the at least one solution to the assembled customer requirements.

18. The system according to claim 16, wherein the operations further comprise
determining whether a plurality of solution packages address at least one same business process.

19. The system according to claim 18, further comprising
excluding at least one solution package from the plurality of solution package.

20. The system according to claim 15, wherein the determining further comprises
determining, based on the determined at least one customer requirement, a category of business processes and a category of non-business process related activities.
